(19) United States
(12) Patent Application Publication
(10) Pub. No.: US 2014/0362395 A1
(43) Pub. Date: Dec. 11, 2014

(54) IMAGE PROCESSING APPARATUS AND METHOD

(71) Applicant: Naoto SHIRAISHI, Kanagawa (JP)

(72) Inventor: Naoto SHIRAISHI, Kanagawa (JP)

(73) Assignee: Ricoh Company, Ltd., Tokyo (JP)

(21) Appl. No.: 14/280,828

(22) Filed: May 19, 2014

(30) Foreign Application Priority Data
Jun. 6, 2013 (JP) 2013-120182

(51) Int. Cl. G06F 3/12

(52) U.S. Cl. CPC G06F 3/1298; G06F 3/1248; G06F 3/1215
USPC 358/1.13

(57) ABSTRACT

An image processing apparatus includes a drawing command generator that analyzes a page description language and generate a drawing command, a drawing processor that draws color information for an image on one plane and an image on a plane for performing translucent process based on the drawing command generated by the drawing command generator, and a first image storage unit that stores the color information for the image on one plane and the image on the plane for performing the translucent process drawn by the drawing processor. The drawing processor repeats drawing for each of the color information for the image on one plane and the image on the plane for performing the translucent process.

### CROSS-REFERENCE TO RELATED APPLICATION

This patent application is based on and claims priority pursuant to 35 U.S.C. §119(a) to Japanese Patent Application No. 2013-120182, filed on Jun. 6, 2013 in the Japan Patent Office, the entire disclosure of which is hereby incorporated by reference herein.

### BACKGROUND

1. Technical Field

The present invention relates to an image processing apparatus and an image processing method.

2. Background Art

Conventionally, in image processing apparatuses such as page printers, it is difficult to satisfy the demand for high image resolution and high-speed printing solely by enhancing the performance of the central processing unit (CPU). Therefore, printer drawing and image processing have come to be carried out using hardware.

It is known that high-speed memory access is necessary for processing drawing in printers, and dedicated memories may be used for that purpose.

As a cost-saving measure, in personal computers (PCs) and game machines with screen sizes of around Video Graphic Array (VGA) level, it is known to include a Static Random Access Memory (SRAM) as a frame memory in an Application Specific Integrated Circuit (ASIC) since the size of the frame memory is small.

However, in printers, an A4 size at 600 dpi resolution, for example, requires about 6800×4720 pixels. It is difficult to include such a large-sized memory in the ASIC.

On the other hand, due to technological developments in semiconductor processing, Dynamic Random Access Memory (DRAM) in main memory is speeding up, and, accordingly, there is a demand for high transfer rates between the CPU and a memory controller. With this trend, there has been developed a general-purpose CPU which includes a memory controller.

### SUMMARY

Example embodiments of the present invention provide an image processing apparatus that includes a drawing command generator that analyzes a page description language and generates a drawing command, a drawing processor that draws color information for an image on one plane and an image on a plane for performing a translucent process based on the drawing command generated by the drawing command generator, and a first image storage unit that stores the color information for the image on one plane and the image on the plane for performing the translucent process drawn by the drawing processor. The drawing processor repeats drawing for each of the color information for the image on one plane and the image on the plane for performing the translucent process.

Further example embodiments of the present invention provide an image processing method implemented by the above-described image processing apparatus.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a printer controller board of an image processing apparatus as an embodiment of the present invention.

FIG. 2 is a schematic diagram illustrating a process performed by the printer control board shown in FIG. 1 as an embodiment of the present invention.

FIG. 3 is a diagram illustrating a band memory included in an ASIC as an embodiment of the present invention.

FIG. 4 is a block diagram illustrating a drawing processor as an embodiment of the present invention.

FIGS. 5A, 5B, and 5C are diagrams illustrating formats of drawing commands as an embodiment of the present invention.

FIG. 6 is a flowchart illustrating a process that the drawing processor executes as an embodiment of the present invention.

FIGS. 7A and 7B are flowcharts illustrating a drawing step by subroutine in S105 shown in FIG. 6 as an embodiment of the present invention.

FIG. 8 is a flowchart illustrating an image processing by an image processor as an embodiment of the present invention.

FIG. 9 is a diagram illustrating an image processing apparatus as an embodiment of the present invention.

FIG. 10 is a diagram illustrating an image processing apparatus as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the conventional image processing apparatuses, there is a problem that cost of a CPU rises in case of processing images by using hardware and cost rises in case of processing images by using a local memory.

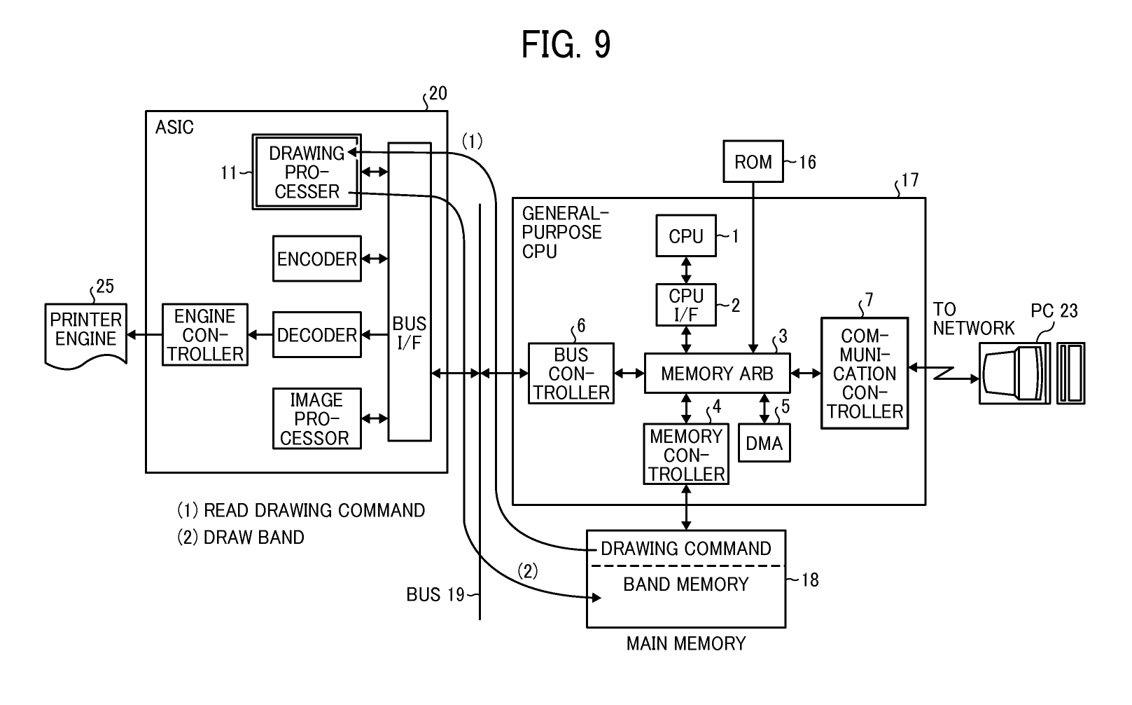

FIG. 9 illustrates an example general-purpose CPU 17, which includes a memory controller 4 as the print controller. An ASIC 20 may be connected to a bus of the general-purpose CPU 17 for processing images as shown in FIG. 9.

The general-purpose CPU 17 shown in FIG. 9 is used as the print controller in an embodiment of the present invention, and that will be described later.

On a different note, eXtensible markup language Paper Specification (XPS), which is a Page Description Languages (PDL), supports translucent drawing, in which translucent images are superimposed on each other in accordance with set processing parameters (translucent values). In the translucent drawing process, it is necessary to store translucent values (24 bits and 8 bits) for R (red) G (green), and B (blue) (24 bits) and translucent values (8 bits) of a band image for each pixel.

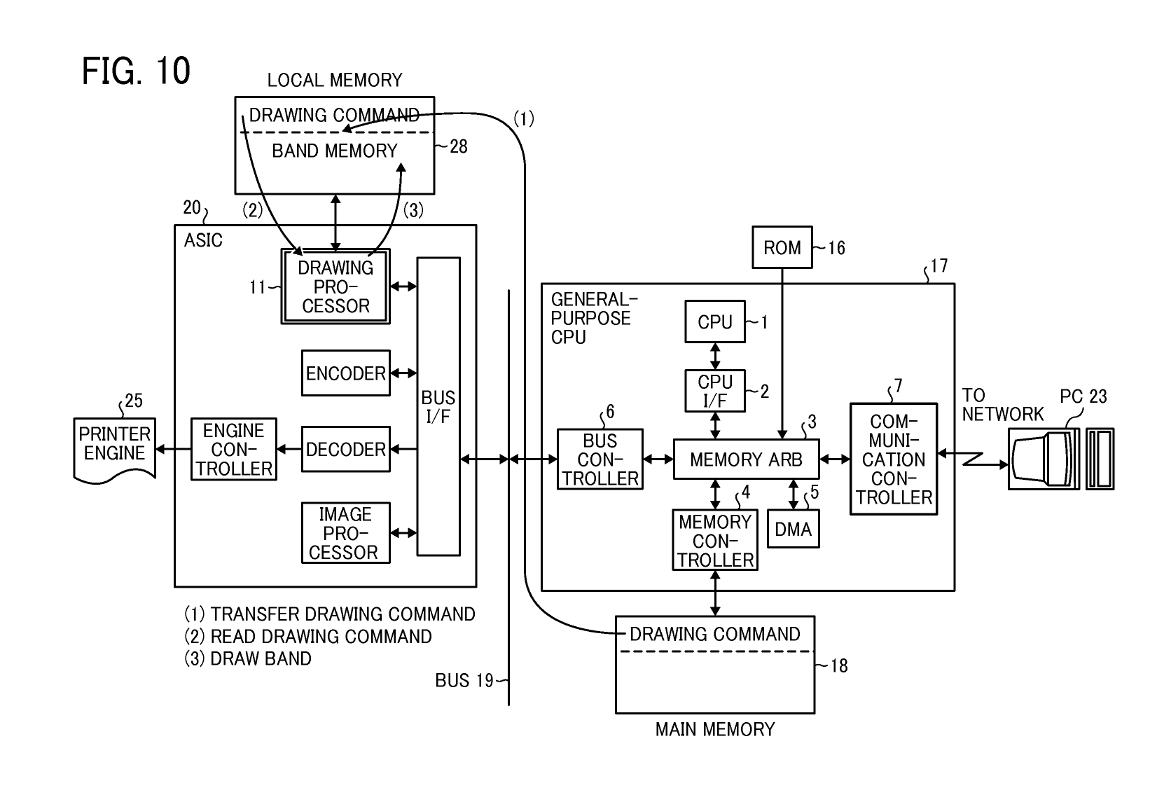

For example, in using the general-purpose CPU 17 shown in FIG. 9 as the print controller, if the ASIC 20 includes a drawing processor 11, it is necessary to access a band memory in a main memory 18 via a bus 19. In this case, there are lots of detailed memory accesses, and it is difficult for the bus transfer rate to reach optimum performance. In addition, hardware that performs processing via other buses has a huge effect. Therefore, while it is possible to adopt a structure in which the ASIC 20 in FIG. 9 includes a local memory 28 (shown in FIG. 10), the structure drives up costs by an amount equal to the local memory 28.

Alternatively, it is possible to include a band memory in the ASIC 20. However, the memory size for an A4 sheet at 600 dpi becomes 128 MB, and it is difficult to include this size of memory in the ASIC 20, and that also drives up the cost of the ASIC 20.

While it is possible to include memory for each R, G, and B band unit in the ASIC 20, doing so requires 7 MB memory assuming that band height is 256 lines.

The band size shrinks if the height of the band is lowered. However, since that results in increasing the number of bands it takes more time for the CPU 1 to generate a command to draw the bands, so it is difficult to reduce the height of the band.

That is, in case of using the ASIC 20 that includes the local memory 28 as shown in FIG. 10 and drawing a printer image with the ASIC 20, there is a concern that the cost of the local memory rises. By contrast, in case of enhancing the performance of the general-purpose CPU 17 and drawing the printer image with the CPU 17, there is concern that the cost of the general-purpose CPU 17 rises.

In the general-purpose CPU 17 that includes a conventional memory controller 4, as shown in FIGS. 9 and 10 in case of accessing the main memory 18 via the bus it is effective to transfer data serially. However, since many small and random accesses to various areas occur during drawing processing, etc., it is difficult to access the memory effectively. Consequently, drawing processing and the like takes a lot of time, and that results in lowering transfer rate of the bus and interfering with memory access by other hardware units.

In case of drawing processing using software only, it is necessary to use a high-priced CPU since a lot of memory accesses are needed.

While it is possible that the ASIC 20 occupies the local memory 28 for drawing as shown in FIG. 10, there is concern that cost rises because of the inclusion of a dedicated memory.

In the following embodiment, an image processing apparatus is provided that realizes translucent processing without expanding the size of the image storage unit and lowering processing speed.

In the following embodiment, in a printer drawing process and a translucent process, the image processing apparatus uses one color plane among R, G, and B and a memory as a small image storage unit for a translucent plane and performs random memory accesses by using the memory.

The image processing apparatus is described in detail below with reference to figures.

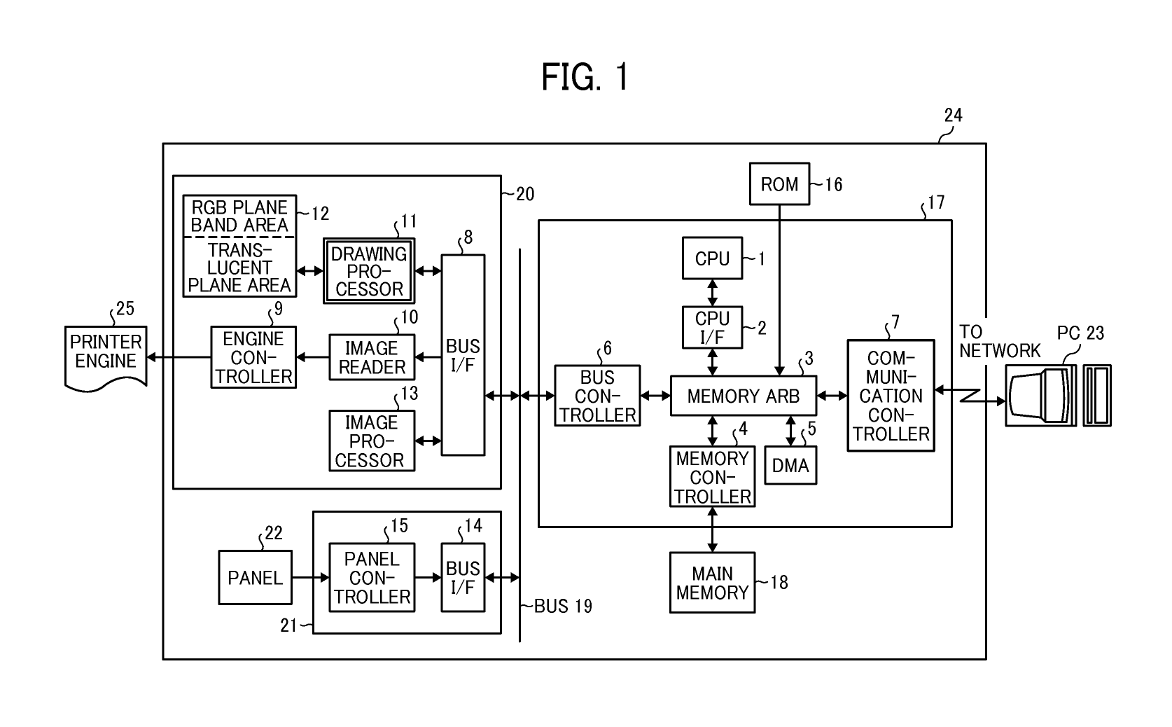

FIG. 1 is a block diagram illustrating a printer controller board of an image processing apparatus in this embodiment of the present invention.

A printer controller board 24 includes a general-purpose CPU (hereinafter referred to as “printer controller”) 17, an image processor (an ASIC 20 here), a ROM 16, a main memory 18 as a main storage unit, a panel control unit 21, and a panel 22. The panel control unit 21 includes a bus interface (I/F) 14 and a panel controller 15.

The printer controller 17 consists of the CPU 1 and various controllers such as a built-in memory controller 4 etc. as shown in FIG. 1.

Here, the CPU 1 controls the whole part of a printer control board 24, analyzes PDL data sent from a PC 23, and generates a drawing command for a drawing processor 11 as a drawing processor in the present invention.

A CPU I/F 2 is an interface included in the CPU 1 and connected to the memory controller 4 and various controllers via a memory arbiter (memory ARB) 3.

The memory arbiter 3 arbitrates between the main memory 18 and the various controllers.

The memory controller 4 controls the main memory and is connected to the various controller and the CPU 1 via the memory arbiter 3.

A Direct Memory Access (DMA) 5 performs direct memory access between the memory controller 4 and an engine controller 9 in the ASIC 20 connected to the bus 19.

A bus controller 6 arbitrates between the bus 19 and each of the peripheral controllers connected the bus 19.

A communication controller 7 is connected to a network and receives various data and commands from the network. The communication controller 7 is also connected to the various controllers via the memory arbiter 3.

The ROM 16 stores various programs and font information such as characters.

The main memory 18 stores drawing commands, image data processed by the drawing commands, and program

The bus 19 connects the printer controller 17 and the image processor 13.

The ASIC 20 reads image data etc. stored in the main memory 18 via the bus 19, performs image processing, and transfers the result of the image processing to the main memory 18 via the bus 19.

The bus I/F 8 is an interface of the bus 19 and is connected to the printer controller 17.

An image reader 10 transfers the image data stored in the main memory 18 to the engine controller 9.

The engine controller 9 controls a printer engine 25.

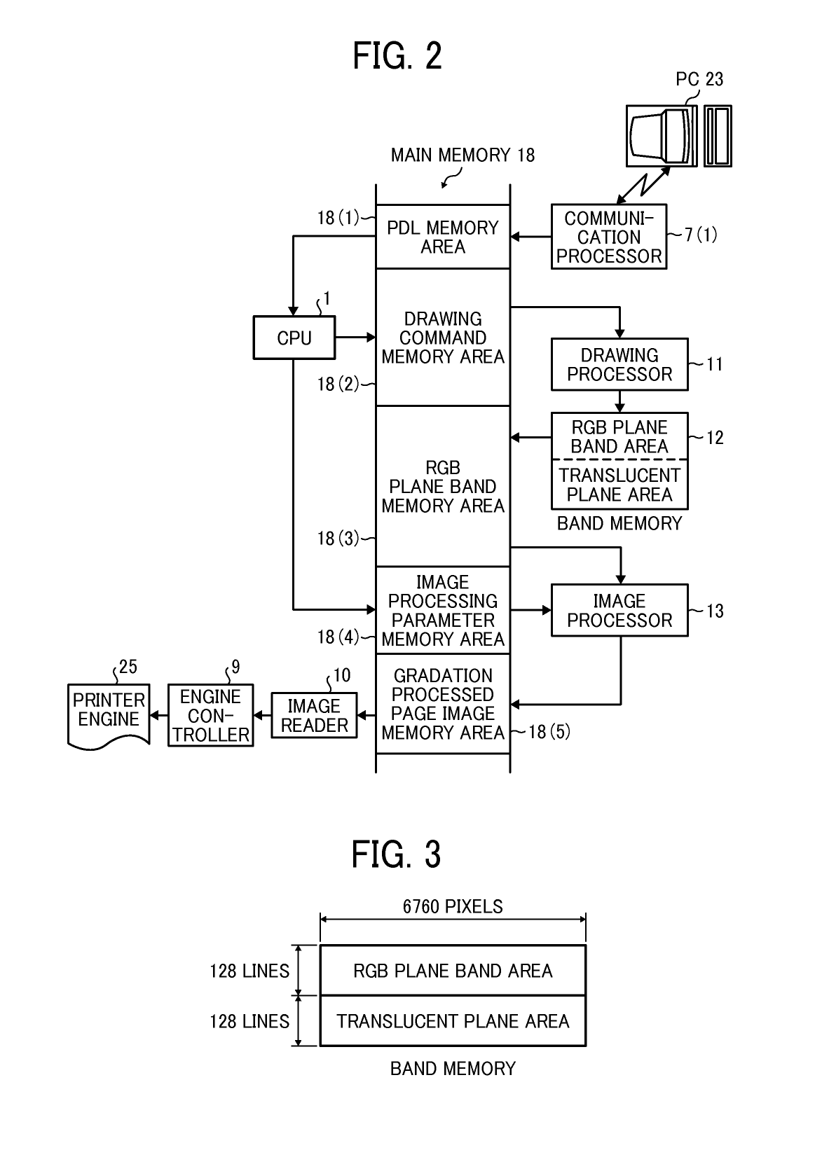

After reading the drawing command generated by the CPU 1, the drawing processor 11 processes drawing to a band plane in the band memory 12 that corresponds to a first image storage unit in the present disclosure included in the ASIC 20 and writes the result of the drawing process in an assigned area in the main memory 18 (RGB plane band memory area 18(3) that corresponds to a second image storage unit shown in FIG. 2).

After reading image data in the RGB band plane stored in the RGB plane band memory area 18(3) sequentially, the image processor 13 performs the image processing on the read image data and transfers the processed image data to a page image after processing gradation memory area 18(5) as a third image storage unit in the present invention in the main memory 18.

The band memory 12 included in the ASIC 20 stores one plane among R, G, and B and a translucent plane that corresponds to a plane for processing image in the present invention. Here, the reason why only one plane is stored is that the memory size included in the ASIC 20 is limited and to include large sized memory results in increasing cost of the ASIC 20. The other reason is that the number of drawing commands becomes large if the band height is low, and that results in lowering processing speed of software and affecting drawing speed. To cope with those issues, the band memory 12 stores only the minimal one plane and the corresponding translucent plane for performing translucent operation.

The reason why the two planes described above are enough is that the translucent operation is performed by using image information (color information) in one color plane among R, G, and B and the translucent value of the band as indicated in a translucent operation expression described later. For example, only color information (color values) of R plane and translucent values in the translucent band are needed to perform the translucent operation on R plane, and G plane and B plane are not needed for that purpose.

The printer engine 25 is a printer engine to execute printing.

The bus I/F 14 in the panel control unit 21 transfers data in the panel controller 15 to the printer controller 17 that includes the memory controller 4.

The panel controller 15 controls the panel 22.

After receiving user operation, the panel 22 passes the content of the operation to the printer controller 17.

The PC 23 accepts user operation to execute printing and generates PDL.

The printer control board 24 controls the printer.

Since drawing is performed by using only image information (color information) of one plane and image information (translucent values) of the plane for performing translucent operation (hereinafter referred to as “translucent plane”) only two band memories are necessary. As a result, it is possible to include the band memory 12 shown in FIG. 1 in the ASIC 20. In addition, since it is unnecessary to include the local memory 28 shown in FIG. 10, it is possible to perform the translucent processing without enlarging the memory size. In addition, since an external memory such as the local memory 28 shown in FIG. 10 is not needed, it is possible to cut costs.

FIG. 2 is a schematic diagram illustrating a process performed by the printer control board 24 shown in FIG. 1 as an embodiment of the present invention.

After generating the PDL data, the PC 23 transfers it to the printer controller 17 in the printer control board 24 via the network.

After receiving the PDL data transferred from the PC 23, the communication processor 7(1) in the communication controller 7 stores it to a PDL memory area 18(1) in the main memory 18.

The CPU 1 writes drawing command in a drawing command memory area 18(2) and image processing parameters in an image processing parameter memory area 18(4) in the main memory 18. That is, the drawing commands (e.g., graphics commands, photo drawing commands, and band definition commands) that the CPU 1 generates based on the PDL data are stored in the drawing command memory area 18(2).

The drawing processor 11 reads the drawing command stored in the drawing command memory area 18(2), performs drawing process in accordance with the read drawing command, and draws a band image of one plane among R, G, and B (e.g., R plane) and translucent band image in the band memory 12 included in the ASIC 20.

A RGB plane band memory area 18(3) stores image data drawn by the drawing processor 11 and transferred by an image data transfer unit as a function implementation unit of the CPU 1. While it is preferable to draw in each plane in order to save memory, it is also performed to draw in the translucent plane simultaneously in order to perform translucent processing.

As described above, the image processing parameter memory area 18(4) stores image processing parameters. As described above, after reading image data in the RGB band plane stored in the RGB plane band memory area 18(3) sequentially, the image processor 13 performs the image processing (image processing for printing, i.e., gradation processing and color conversion processing to YMCK (Y: yellow, M: magenta, C: cyan, and K: black) on the read image data and transfers the processed image data to the page image after processing gradation memory area 18(5) as a third image storage unit in the present invention in the main memory 18.

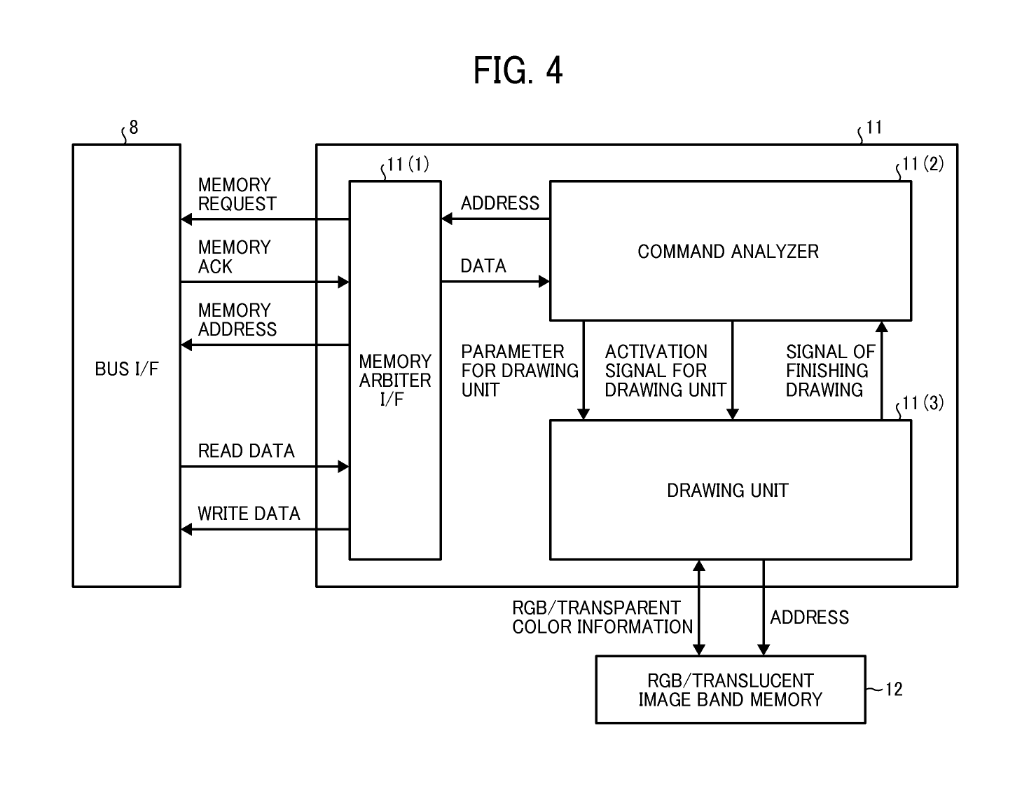

FIG. 3 is a diagram illustrating the band image memory 12 (hereinafter referred to as “band memory”) included in the ASIC 20 shown in FIG. 1.

As shown in FIG. 3, the band memory 12 consists of a plane band area of one color among R, G, and B and a translucent plane area. In this case, the height of the plane area (band) is 128 lines, and the width of the plane area is 6760 pixels. The band memory stores one color plane and translucent image data. The band memory 12 occupies only a half size of pixel image data of R, G, B, and translucent. For example, in the case of 128 lines, size of 1.7 MB is necessary assuming 600 dpi.

Here, the reason why the translucent plane is needed is that a destination translucent values is necessary in a translucent operation expression of XPS (described later).

That is, in the translucent operation expression described later, in case of drawing each color of R, G, and B, the translucent plane is necessary since its value (translucent value) is updated each time drawing is performed. Therefore, in this embodiment, at least one plane among R, G, and B and the translucent plane are included, and the translucent processing is realized by drawing in at least one plane among R, G, and B and the translucent plane simultaneously. As a result, the memory size can be reduced.

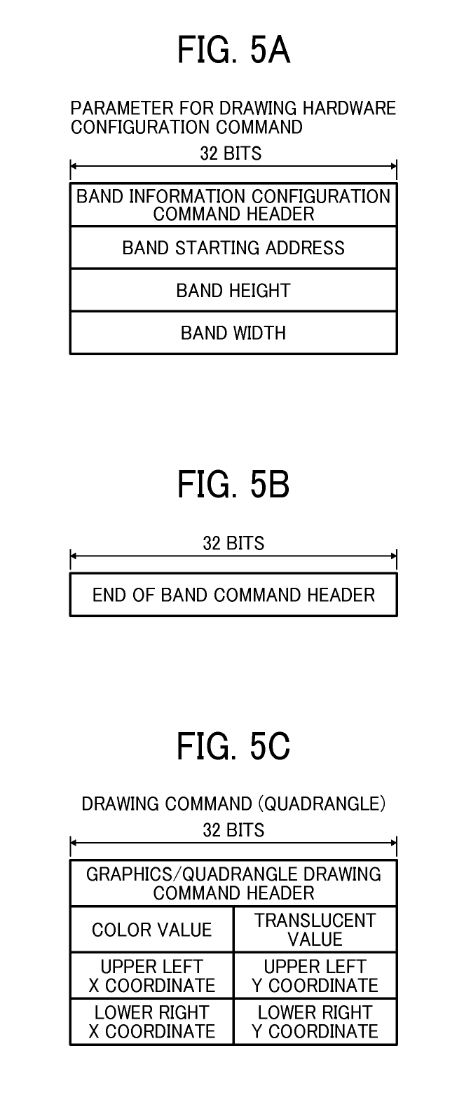

FIG. 4 is a block diagram illustrating the drawing processor 11.

A memory arbiter 11(1) is an interface between the bus I/F 8.

A command analyzer 11(2) reads the drawing command, analyzes the drawing command, launches a drawing unit 11(3) by transferring the parameter to the drawing unit 11(3), and analyzes next command after finishing drawing. After receiving the parameter of the drawing command from the command analyzer 11(2), the drawing unit 11(3) draws a band image of one plane among R, G, and B (band plane image) and a translucent image in the band memory 12.

As shown in FIG. 3, the band memory 12 stores low-height band image data (i.e., one plane band image data among R, G, and B and translucent image data). By comparison, assuming A4 size in 600 dpi, page height is 4720 lines.

As shown in FIG. 4, the memory arbiter I/F 11(1) transfers a memory request signal, memory address, and write data to the bus I/F 8, and the bus I/F 8 transfers a memory acknowledge signal that permits to access in response to the memory request described above and read data from the memory to the memory arbiter I/F 11(1). The command analyzer 11(2) transfers address to the memory arbiter I/F 11(1), and the memory arbiter I/F 11(1) transfers data to the command analyzer 11(2). The command analyzer 11(2) transfers parameters for the drawing unit and an activation signal for the drawing unit to the drawing unit 11(3). The drawing unit 11(3) transfers a drawing finish signal to the command analyzer 11(2).

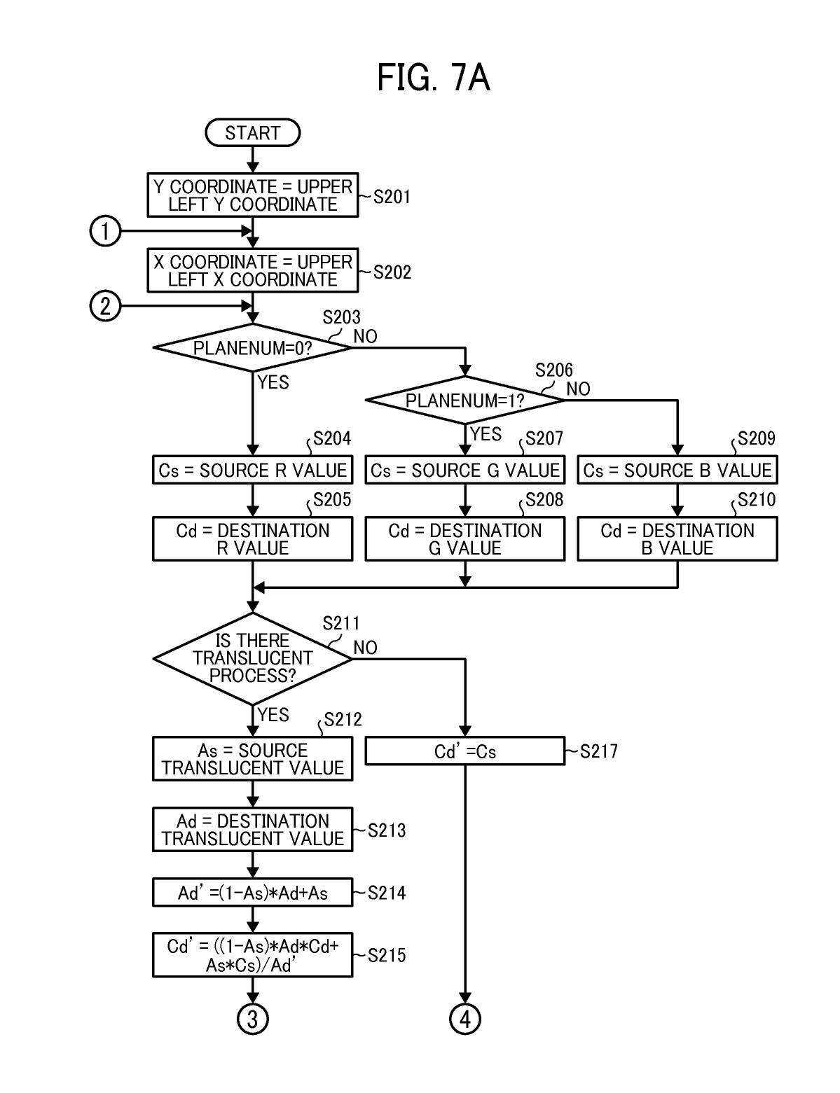

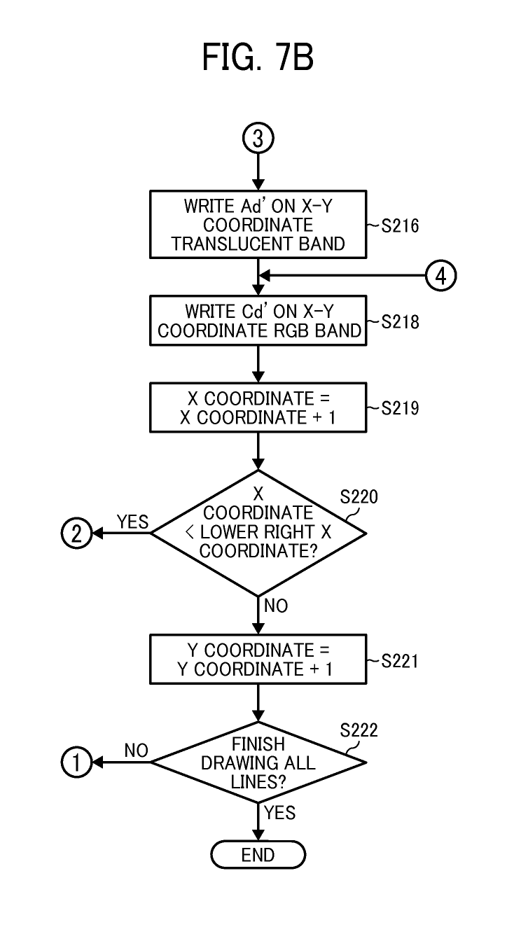

The drawing unit 11(3) transfers address to the band memory 12 that stores RGB and translucent data. The color information on the RGB and translucent image is exchanged between the band memory 12 that stores RGB and translucent data and the drawing unit 11(3). Specifically, that will be described in detail with reference to FIGS. 6 and 7 etc.

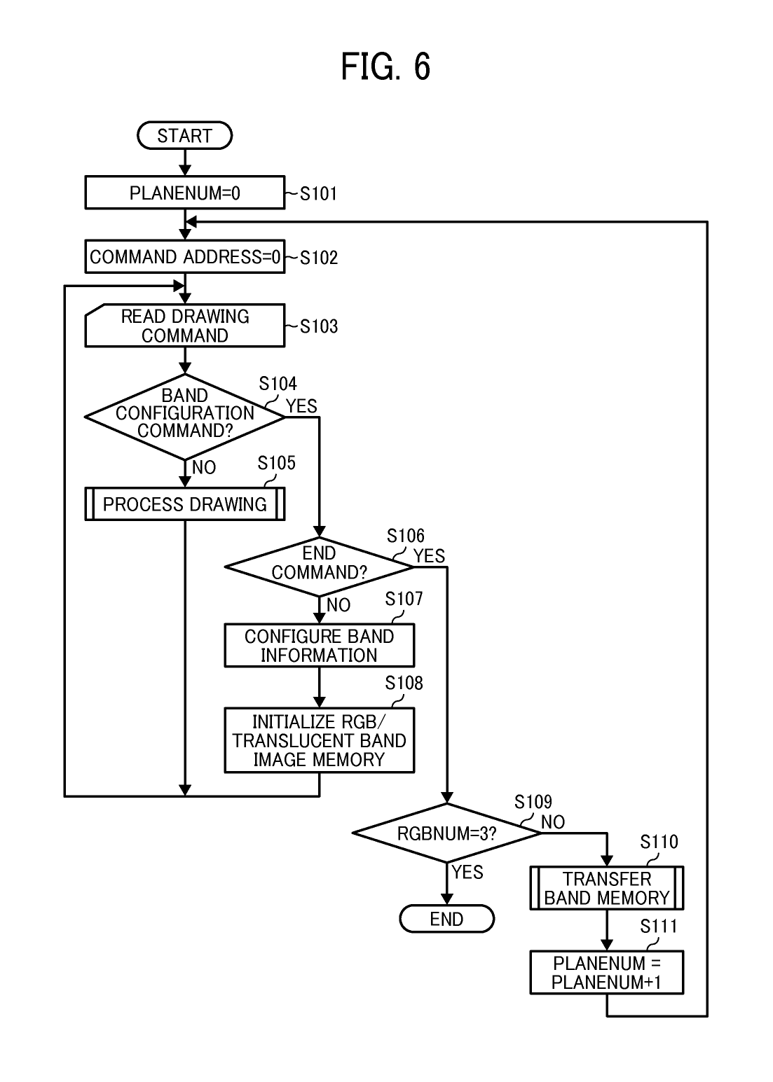

FIGS. 5A, 5B, and 5C are diagrams illustrating formats of drawing commands.

That is, 32-bit formats of drawing commands that the CPU 1 generates converting from the PDL data are shown in FIG. 5. The drawing commands are analyzed by the command analyzer 11(2) in the drawing processor 11 (shown in FIG. 4), and the drawing unit 11(3) executes the drawing command (performs drawing).

The drawing commands can be categorized as a drawing hardware parameter configuration command, graphics drawing command, or photo image drawing command.

FIGS. 5A and 5B are formats of the drawing hardware parameter configuration command. The drawing hardware parameter configuration command configures parameter values of various drawing parameters. That is, among the drawing hardware parameter configuration commands, a band initialization command is shown in FIG. 5A, includes a band information configuration command header in its forefront, and defines front address of the band, band height, and band width as contents of the command. The band initialization command initializes the band to “white” as its initial value. The band finish command is shown in FIG. 5B and indicates that it is finished to draw in the defined band. After receiving the band finish command, the command analyzer 11(2) shown in FIG. 4 finishes the drawing process and instructs to perform processing the image.

The graphics drawing command executes drawing graphics. The photo drawing command executes drawing photos.

FIG. 5C is a diagram illustrating a quadrangle drawing command that draws a quadrangle from the upper left x-coordinate to the lower right y-coordinate among the graphics drawing commands.

Next, a translucent operational expression that calculates a destination translucent value after drawing and a destination color value (color value) after drawing written in the band memory 12.

That is, assuming As as a translucent value of the source data (the translucent value in the drawing command shown in FIG. 5C), Ad as a destination translucent value (the translucent value in the drawing destination, i.e., the band memory 12), Ad′ as a destination translucent value after drawing (the translucent value written in the band memory 12), Cs as a color value of the source data (the color value in the drawing command shown in FIG. 5C), Cd as a destination color value (the color value in the band memory 12), and Cd′ as a destination color value after drawing (the color value written in the band memory), Ad′ can be calculated based on Equation 1 shown below, and Cd′ can be calculated based on Equation 2 shown below.

Ad′=(1−As)×Ad+As Equation 1

Cd′=((1−As)×Ad×Cd+As×Cs)÷Ad′ Equation 2

The band memory 12 stores a band image that the drawing processor 11 draws. Each time after finishing drawing process for one plane, only image information for one plane among R, G, and B planes (color information; color value; Cd′) is transferred to the RGB plane band memory area 18(3) in the main memory 18. The reason why the translucent image information (translucent value; Ad′) is not transferred in this case is that the translucent plane is work information used for generating the image information of one plane among R, G, and B planes (color value; Cd′) only in the above equations.

After transferring one plane, e.g., R plane, similarly, the translucent operation and drawing are performed for each of other planes, i.e., G and B planes. After performing the translucent operation by using the translucent operational expression, each plane is transferred to the RGB plane band memory area 18(3) in the main memory 18. Here, it is possible to transfer data effectively by performing accessing addresses in the RGB plane band memory area 18(3) serially and sequentially via the bus 19.

After finishing transferring all planes, i.e., R, G, and G planes, the band for next page is processed, and similarly this process is repeated until the end of the pages.

After finishing the drawing process for each page by the drawing processor 11, as described above, the image processor 13 reads image processing parameters from the image processing parameter memory area 18(4) in the main memory 18. Simultaneously, the image processor 13 reads RGB image data from the RGB plane band memory area 18(3) and performs image processing (gradation processing and color conversion processing). Subsequently, the image processor 13 writes the ROB image in the page image after processing gradation memory area 18(5) as the third storage unit in the present invention in the main memory 18.

The image reader 10 transfers the image data in the page image after processing gradation memory area 18(5) in the main memory 18 to the engine controller 9 in synchronization with the printer engine 25. The engine controller 9 transfers the RGB image data received from the image reader 19 to the printer engine 25. The printer engine 25 performs printing the RGB image data.

FIG. 6 is a flowchart illustrating a process that the drawing processor 11 executes.

In this process, first, a plane number to be processed in this flow is initialized (PLANENUM=0) in S101. (e.g., PLANENUM=0 indicates the R plane, PLANENUM=1 indicates the G plane, and PLANENUM=2 indicates the B plane.) Subsequently, address of a reading command is initialized (command address=0) in S102, and the drawing command pointed by the command address is read in S103.

Next, the drawing command is analyzed by the command analyzer 11(2), and it is determined whether or not the drawing command is the band configuration command in S104. If the drawing command is not the band configuration command (NO in S104), the drawing process is performed in S105. The drawing process will be described in detail later with reference to flowcharts in FIGS. 7A and 7B. After performing the drawing process, the step goes back to S103.

If the drawing command is the band configuration command (YES in S104), it is determined whether or not the drawing command is the band finish command in S106. If the drawing command is not the band finish command (NO in S106), it is determined that the drawing command is the band information configuration command, the band information is configured in S107, and the band memory 12 (RGB and translucent band memory) is initialized in S108. After initializing, the step goes back to S103.

If the drawing command is the band finish command (YES in S106), after checking the plane number, it is determined whether or not the drawing process is performed on all planes, i.e., it is determined whether or not the plane number is 3 in S109. Here, if the number of the planes is 3 (RGBNUM=3) (YES in S109), the process ends since the drawing process is performed on all of R, G, and B planes.

If the drawing process has not been performed on all planes yet (NO in S109), the image information in the drawn plane is transferred to the RGB plane band memory area 18(3) in the main memory 18 shown in FIG. 2 in S110. Here, after incrementing the plane number by 1 in S111, the step goes back to S102, and the following steps are repeated.

As described above, after reading the drawing command from the drawing command memory area 18(2) in the main memory 18, the drawing process 11 draws the image information (color information) and the translucent value for one plane in the band memory 12 performing the translucent process. After finishing drawing the image information for one plane of one band, the drawing processor 11 transfers the image information (color information) to the RGB plane band memory area 18(3) in the main memory 18. After performing this process on all color planes (i.e., R, G, and B planes), the process ends.

FIGS. 7A and 7B are flowcharts illustrating the drawing step by subroutine in S105 shown in FIG. 6.

First, the drawing processor 11 sets y-coordinate to the upper left y-coordinate of the drawing command shown in FIG. 5C in S201 and sets x-coordinate to the upper left x-coordinate of the drawing command shown in FIG. 5C in S202. Subsequently, R, G, and B planes are switched in accordance with the plane number (0, 1, and 2) in S203 and S206, the color specified by the drawing command is considered as the source R, G, and B color values in S204, S207, and S209, and the Cs value (source color value) is specified. In addition, color value at x-y coordinate in the RGB plane band in the band memory 12 is considered as the destination R, G, and B color values, and the Cd value (destination color value) is specified in S205, S208, and S210.

Next, it is determined whether or not the drawing process requires the translucent process from the format of the drawing command in S211. If the translucent process is not required (NO in S211), Cs value (source color value) is set to Cd′ (destination color value after drawing) (Cd′=Cs) in S217, and the step proceeds to S218.

By contrast, if the translucent process is required, i.e., if the translucent process is performed (YES in S211), the translucent value in the drawing command is set to As (the translucent value in the source data) in S212, and the translucent value at x-y coordinate in the band memory 12 is set to Ad (Ad is the destination translucent value) in S213. A new Ad′ (the destination translucent value after drawing (Ad′=(1−As)×Ad+As)) is calculated from the translucent value of As and the translucent value of Ad in S214. In addition, a new Cd value after performing the translucent process (the destination translucent value after drawing: Cd′=((1−As)×Ad×Cd+As×Cs)÷Ad′) is calculated from the values of As, Ad, Ad′, Cs, and Cd in S215. Subsequently, Ad′ (the destination translucent value after drawing) is written in the translucent band at y-x coordinate in S216, and Ad′ value is set to the translucent band at y-x coordinate in the band memory 12. In addition, Cd′ (the destination translucent value after drawing) is written in the RGB band at y-x coordinate in S218 and is set to the RGB plane band memory area 18(3) at x-y coordinate in the band memory 12.

Next, x-coordinate is updated (x-coordinate=x-coordinate+1) in S219, and it is determined whether or not the x-coordinate reaches the lower right x-coordinate in the drawing command in S220. If the x-coordinate has not reached the lower right x-coordinate in the drawing command (i.e., x-coordinate<lower right x-coordinate) (YES in S220), the step goes back to S203, and the process is performed on the line at the y-coordinate repeatedly.

If the x-coordinate reaches the lower right x-coordinate (NO in S220), the y-coordinate is updated (y-coordinate=y-coordinate+1) in S221, and the steps from S202 are repeated until the drawing process is performed on all lines. If the drawing process is performed on all lines (YES in S222), the process ends.

As described above, the drawing processor 11 reads the destination color value (color information) and the translucent value from the configured band memory 12 and draws the color value and the translucent value on one plane after performing the translucent process by using the source color value and the translucent value to be drawn.

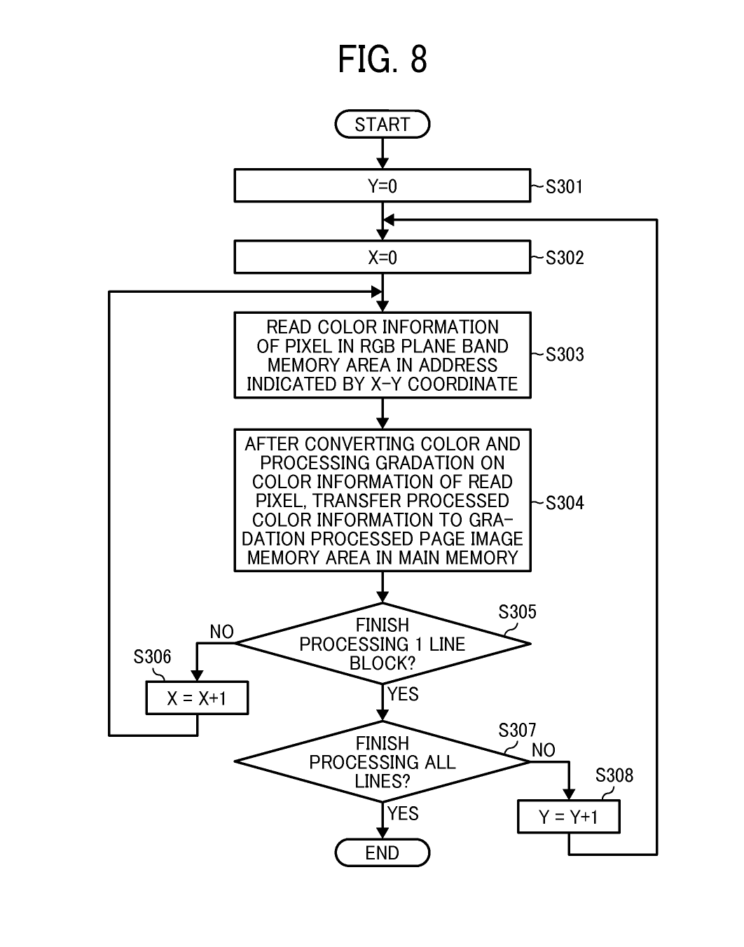

FIG. 8 is a flowchart illustrating an image processing performed by the image processor 13.

In this flowchart, first, each of x-coordinate and y-coordinate is initialized (y=0, x=0) in S301 and S302. These x and y values indicate the coordinate in the RGB plane band memory area 18(3) in the main memory 18. Subsequently, the pixel value (color information of the pixel) in the address pointed by the x and y values is read in S303. The process for printing, i.e., color conversion to CMYK data and gradation process in this case, is performed on the color information. In addition, the processed color information is transferred to the page image memory area 18(5) after performing the gradation process in S304.

Next, it is determined whether or not it is finished to perform the process on one line (if a block for one line is processed) in S305. If it is determined that it is not finished to perform the process on one line yet (NO in S305), the x value is updated to x+1 in S306, and the step goes back to S303.

By contrast, if it is determined that it is finished to perform the process on one line (YES in S305), it is determined that it is finished to perform the process on all lines in S307. If it is determined that it is not finished to perform the process on all lines in S307 (NO in S307), the y value is updated to y+1 in S308, and the step goes back to S302. By contrast, if it is determined that it is finished to perform the process on all lines (YES in S307), the process ends.

As described above, in the image processing apparatus in this embodiment, the ASIC shown in FIG. 3 includes the small band memory whose height is low such as 128 lines, and the drawing process is performed in small units. It should be noted that, in case of drawing the band in the small band memory whose height is low, it is necessary to issue lots of drawing commands, and that results in making performance of software that generates the drawing commands deteriorated. To cope with the problem, it is generally necessary to make the band height high. However, in this embodiment, the ASIC includes the band memory that stores one plane among R, G and B and the translucent plane, and the transfer rate of the bus can be reduced. In addition, the band is drawn within the ASIC, and the drawn image is returned to the main memory via the bus by using the serial access. Consequently, by utilizing the bus transfer rate to the maximum extent, the processing speed can be prevented from deteriorating.

In addition, in this embodiment, the band memory that stores one plane among R, G, and B and the translucent plane that is absolutely necessary since the translucent value changes during drawing is adopted. Consequently, it has an advantage that it only has 2 planes and half memory size compared to the conventional band memory that stores 4 planes, i.e., R, G, B, and translucent planes.

The present invention also encompasses a recording medium storing a program that executes an image processing method, performed by an image processing apparatus. The image processing method, performed by the image processing apparatus, includes the steps of analyzing a page description language and generating a drawing command, drawing color information for an image on one plane and an image on a plane for performing translucent process based on the drawing command generated in the analyzing step, and storing the color information for the image on one plane and the image on the plane for performing the translucent process drawn in the drawing step. In the drawing step, drawing process is performed for each of the color information for the image on one plane and the image on the plane for performing the translucent process.

Each of the functions of the described embodiments may be implemented by one or more processors or processing circuitry. Processing circuitry includes a programmed processor, as a processor includes circuitry. A processor also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An image processing apparatus, comprising:
a drawing processor to generate a drawing command based on a page description language, and to
repeatedly draw color information for an image on one plane and an image on a plane for performing a translucent process based on the drawing command, for each of the color information for the image on one plane and the image on the plane for performing the translucent process; and
a first storage area to store the color information for the image on one plane and the image on the plane for performing the translucent process drawn by the drawing processor.

2. The image processing apparatus according to claim 1, wherein:
the drawing processor further repeatedly transfers image data of the color information for the image on one plane for each drawing of the color information for the image on one plane, the image processing apparatus further comprising:
a second storage area to store the image data transferred by the drawing processor.

3. The image processing apparatus according to claim 2, further comprising:
an image processing circuit to read the image data stored in the second storage area and; and
a third storage area to store the image data processed by the image processing circuit.

4. The image processing apparatus according to claim 1, wherein:
the drawing processor is a printer control unit, and
the first storage area is included in the image processing circuit, the apparatus further comprising:
a main memory that includes the second storage area.

5. The image processing apparatus according to claim 1, wherein the drawing processor performs the translucent process based on a translucent value for the translucent process and a color value of an image on a plane to be drawn.

6. The image processing apparatus according to claim 5, wherein the third storage area is included in the main memory.

7. The image processing apparatus according to claim 6, wherein the image processing circuit is an Application-Specific Integrated Circuit.

8. An image processing method, comprising:
generating a drawing command based on a page description language;
repeatedly drawing color information for an image on one plane and an image on a plane for performing a translucent process based on the drawing command, for each of the color information for the image on one plane and the image on the plane for performing the translucent process; and
storing the color information for the image on one plane and the image on the plane for performing the translucent process drawn in the drawing step.

9. The image processing method according to claim 8, further comprising:
further repeatedly transferring image data of the color information for the image on one plane for each drawing of the color information for the image on one plane; and
storing the image data transferred in the transferring step.
